(19) United States
(12) Patent Application Publication
(10) Pub. No.: US 2026/0159643 A1
(43) Pub. Date: Jun. 11, 2026

(54) PROCESS FOR THE PRODUCTION OF A POLYESTER (CO)POLYMER

(71) Applicant: Avantium Knowledge Centre B.V., Amsterdam (NL)

(72) Inventors: Gerardus Johannes Maria Gruter, Amsterdam (NL); Bing Wang, Amsterdam (NL); Robert-Jan Van Putten, Amsterdam (NL); Bruno Bottega Pergher, Amsterdam (NL)

(21) Appl. No.: 19/125,612

(22) PCT Filed: Oct. 30, 2023
(86) PCT No.: PCT/EP2023/080226

§ 371 Date: Apr. 29, 2025

(30) Foreign Application Priority Data
Nov. 1, 2022 (EP) 22204859.7

(51) Int. Cl. C08G 63/672

(52) U.S. Cl. CPC C08G 63/672

(57) ABSTRACT

The invention relates to a process for the production of a polyester (co)polymer, comprising the use of a diguaiacyl dicarboxylate ester as a chain extender, wherein the dicarboxylate is derived from a dicarboxylic acid selected from (hetero)aromatic dicarboxylic acids, and from C3-C18 aliphatic dicarboxylic acids which may be linear, cyclic or branched.

The process is an efficient process for the production of novel and existing polyester (co)polymers with high molecular weight, and optionally without the need for the addition of a metal catalyst.

### FIELD OF THE INVENTION

The invention relates to a process for the production of a (high molecular weight) polyester (co)polymer.

### BACKGROUND OF THE INVENTION

One of the most important goals of polymerization processes is to obtain polymers with a molecular weight high enough for the desired application(s). This is important as the molecular weight of the polymer relates to polymer performance e.g., strength, toughness and durability. The use of polymers with insufficient molecular weight may lead to application failures. Therefore, many studies concerning polymerization processes and the conditions used in those processes relate to realizing the target (high) molecular weight.

Polyesterification is a reversible reaction with a relatively low equilibrium constant. As a consequence, removal of the condensation product(s) has an impact on the molecular weight that can be achieved. Melt polycondensation at reduced pressure is commonly used in polyesterification processes for removal of the condensation product(s). However, the increase of molecular weight of the polymers during that process also increases the viscosity of the melt material, which complicates the removal of condensation product(s). This may eventually become a limiting factor. Removal of condensation product(s) can be improved, for example by using higher temperatures, longer reaction times, catalysts and improved reactor designs. However, under melt conditions, limited mass transfer due to high viscosity of the melt material, in combination with longer residence times and (potential) chemical degradation, may limit the possibilities to obtain higher molecular weights. For example, to obtain high molecular weights of polyethylene terephthalate (PET) necessary for bottles (intrinsic viscosity (IV) of 0.73-0.85 dL/g) and industrial yarns (IV>1.2 dL/g), an additional solid-state polymerization (SSP) step may be required. In SSP, polymer pellets are heated below the melting point while being rotated under a nitrogen flow or vacuum. A drawback of SSP is that due to the low mobility of the end groups and condensate in the solid state, this is time and energy consuming, and therefore an expensive process.

In order to obtain polyesters of high molecular weights, generally (metal) catalysts are used in the process. For example, the majority of PET currently is produced using antimony (Sb) catalysts. However, antimony resources are becoming more and more scarce, and there are concerns about depletion of the natural reserves. Furthermore, in medical applications metal catalysts are often undesired because of toxicity.

When less reactive diols such as isosorbide are introduced into a polyester (e.g. producing PEIT), it becomes even more difficult to obtain sufficiently high molecular weights. Incorporation of isosorbide is interesting due to its additional benefits regarding thermomechanical stability and mechanical performance, which opens new possibilities for applications. Isosorbide is however less reactive due to its secondary alcohol groups, and melt polycondensation becomes considerably more difficult with increasing isosorbide content. Furthermore, the crystallinity of the polymer is lost with isosorbide contents above around 15%, which makes it impossible to use SSP, as an amorphous polymer would clump together.

Another route for producing high molecular weight polymers utilizes a so-called chain extender after melt polycondensation (see e.g. P. Raffa et al., Reactive & Functional Polymers 72 (2012) 50-60). Chain extenders are very reactive molecules which react with the remaining functional chain ends (alcohol and/or acid) to increase the molecular weight. Only little chain extender is needed, as already a considerable chain length is usually obtained after melt polycondensation. Due to the high reactivity of the chain extender considerably less time and less harsh conditions are required to obtain high molecular weight. This can be beneficial to reduce cost by cutting down on polymerization conditions (temperature, time, catalyst, reactor), or to eliminate the need for SSP. Various chain extenders have been used for the production of high molecular weight polyesters, for example ethylene carbonate, bis-oxazolines, pyromellitic dianhydride, organic phosphites, di-isocyanates, di-epoxides, carbonyl biscaprolactam, diphenyl carbonate, diphenyl terephthalate, bisketenimines, and bislactams.

However, the use of chain extenders may come with certain disadvantages. Chain extenders are introduced into the polymer chain and thus become part of the molecular structure of the polyester. The groups that are incorporated into the polymer backbone inevitably influence the properties of the material. Furthermore, often side reactions occur, such as crosslinking or chain scission, which also change the physical properties of the polymer. Moreover, some chain extenders are considerably toxic, on their own, or as residue in polymer, thereby excluding the use thereof for food-grade applications. These drawbacks are probably the reason why today chain extenders are rarely the standard process in commercial polyester production.

Therefore, there is a need for alternative, improved processes for the production of high molecular weight polyesters, which do not have (all) the drawbacks of the use of many of the commonly known chain extenders.

### SUMMARY OF THE INVENTION

According to the present invention, such an improved process is provided. The present invention relates to a process for the production of a polyester (co)polymer, comprising the use of a diguaiacyl dicarboxylate ester (also: bis(2-methoxyphenyl) dicarboxylate ester) as a chain extender, wherein the dicarboxylate is derived from a dicarboxylic acid selected from (hetero)aromatic dicarboxylic acids, and from C3-C18 aliphatic dicarboxylic acids which may be linear, cyclic or branched.

Advantageously, the inventors have found that the guaiacyl group has exceptional leaving group properties in transesterification reactions. Consequently, the high reactivity of the diguaiacyl dicarboxylate ester allows for performing reactions at relatively low temperatures and provides flexibility in its use in polymerization processes.

Favorably, the process of the invention allows for the preparation of polyester (co)polymers with high molecular weights, even in the absence of a catalyst. Also, the thermal properties of the high molecular weight polymers that are produced are generally improved, e.g. higher glass transition temperatures can be obtained than those of (co)polymers produced when using prior art processes.

A wide range of polyester (co)polymers may conveniently be produced using the diguaiacyl chain extender of the present invention. An advantageous process is provided herewith for the preparation of both existing and, suitably, novel polyester (co)polymers with relatively high number average molecular weights.

Thus, as a further aspect, the invention relates to certain novel polyester (co)polymers with high molecular weights, and free of a metal catalyst.

In addition, the invention provides a composition comprising any one of said novel polyester (co)polymers and in addition one or more additives and/or one or more additional polymers.

Further, the invention provides an article comprising the polyester (co)polymer according to the present invention or a composition comprising said polyester (co)polymer and one or more additives and/or additional (co)polymers.

The novel high molecular weight polyester (co)polymers and/or compositions produced according to the invention can advantageously be used in a broad range of (industrial) applications, such as in fibres, injection (blow) moulded parts and bottles, 3D printing, packaging materials, etc.

### DETAILED DESCRIPTION OF THE INVENTION

The present invention relates to a process for the production of a polyester (co)polymer, in particular for the production of a high molecular weight polyester (co)polymer.

By a “polyester” herein is understood a polymer comprising a plurality of monomer units linked via ester functional groups in its main chain. An ester functional group can be formed by reacting a hydroxyl group (—OH) with a carboxyl/carboxylic acid group (—C(═O)OH). Typically, a polyester is a synthetic polymer formed by the reaction of one or more bifunctional carboxylic acids with one or more bifunctional hydroxyl compounds. Polyesters may also comprise units derived from monomers carrying both a hydroxyl group and a carboxylic acid group, such as hydroxycarboxylic acids, like lactic acid (LA) and glycolic acid (GA), and hydroxyalkanoates (HA), and the like. By a “polyester copolymer” is herein understood a polyester wherein three or more types of monomer units are joined in the same polymer main chain. By the term “starting polyester (co)polymer” herein is understood the initial polyester (co)polymer that is used as a starting point to increase its molecular weight.

By a “monomer unit” is herein understood a unit as included in a polyester (co)polymer or oligomer, which unit can be obtained after polymerization of a monomer, that is, a “monomer unit” is a constitutional unit contributed by a single monomer or monomer compound to the structure of the polymer or oligomer, herein in particular the smallest diol or di-acid repeating unit.

By a “monomer” or “monomer compound” is herein understood the smallest building block used as the starting compound to be polymerized, such as a diol or di-acid compound, but may also be a hydroxycarboxylic acid.

By an “oligomer” or “oligomer compound” is herein understood a molecular structure comprising an in total average number of monomer units of in the range from equal to or more than 2 to equal to or less than 50 monomer units, and preferably at least 25 monomer units. Next to diol and di-acid derived monomer units, also other monomer units may be part of the oligomer, such as hydroxycarboxylic acid derived monomer units, in particular derived from α-hydroxycarboxylic acids, such as glycolic acid, lactic acid, mandelic acid, 3-alkoxy carbonic acid, and the like.

The process of the invention relates to a process for the production of a polyester (co)polymer. The process may comprise several stages. Suitably the process according to the invention may comprise a (trans)esterification stage, e.g. reacting [(bi)cyclic]diol monomers with monomers of dicarboxylic acids and/or hydroxycarboxylic acids or ester derivatives thereof, followed by a polycondensation stage. The transesterification stage may suitably be preceded by an introduction stage, wherein the monomers are introduced into a reactor. The polycondensation stage may suitably be succeeded by a recovery stage, wherein the polyester (co)polymer is recovered from a reactor.

The monomers (dicarboxylic acid(s) or ester derivative thereof, and/or hydroxycarboxylic acids and diol compound(s)) in the (co)polymer production process can be any suitable diacid and any suitable diol known for polyester preparation. A person skilled in the art will understand what starting materials to select for the desired polyester (co)polymer product. Preferred dicarboxylic acids comprise (hetero)aromatic dicarboxylic acids, 1,4-cyclohexanedicarboxylic acid, diglycolic acid and C3-C18 aliphatic dicarboxylic acids which may be linear, cyclic or branched, in particular linear dicarboxylic acids of the formula HOOC(CH₂)ₙCOOH, wherein n is an integer of 1 to 20. Hydroxycarboxylic acid derived monomes are in particular selected from α-hydroxycarboxylic acids, such as glycolic acid, lactic acid, mandelic acid, 3-alkoxy carbonic acid, and the like.

According to the process, a diguaiacyl dicarboxylate diester is used as a chain extender, wherein the dicarboxylate is derived from a dicarboxylic acid selected from (hetero)aromatic dicarboxylic acids, and from C3-C18 aliphatic dicarboxylic acids which may be linear, cyclic or branched. Preferably, the dicarboxylate is derived from a (hetero)aromatic dicarboxylic acid, and is particularly the dicarboxylate is derived from terephthalic acid, isophthalic acid or 2,5-furandicarboxylic acid. In another embodiment, the dicarboxylate is derived from a C3-C18 aliphatic dicarboxylic acid, and preferably selected from 1,4-cyclohexanedicarboxylic acid, diglycolic acid, and linear dicarboxylic acids of the formula HOOC(CH₂)ₙCOOH wherein n is an integer of 1 to 20. Preferred linear dicarboxylic acids from which the dicarboxylate is derived are succinic acid, adipic acid, and suberic acid, wherein especially succinic acid is preferred. Accordingly, preferred chain extenders are diguaiacyl terephthalate, diguaiacyl furanoate and diguaiacyl succinate.

Guaiacol (2-methoxyphenol), which is produced as a side product in the present process, is considerably less toxic than phenol, which is typically produced. Furthermore, guaiacol can be sourced from the abundantly available renewable lignin. Notably, the inventors have found that a diguaiacyl dicarboxylate ester is significantly more reactive than its diphenyl counterpart in transesterification reactions, advantageously resulting in reduced polymerization times and temperatures.

Advantageously, the current process allows for the production of high molecular weight polyester (co)polymers, wherein—in case the dicarboxylate of the chain extender is derived from the same dicarboxylic acid as one that is used as one of the monomers for the production of said polyester (co)polymer—the use of the chain extender leaves no trace in the end product.

In an embodiment, the present invention comprises a stepwise process, which comprises in a first step providing or producing a polyester (co)polymer of insufficient chain length having mainly hydroxy end groups (i.e. at least 80%, preferably at least 90%, of the end groups is a hydroxy group), and subsequently adding the diguaiacyl dicarboxylate diester chain extender. The amount of hydroxy end groups may suitable be determined by using commonly known ¹H NMR techniques.

By the wording “a polyester (co)polymer of insufficient chain length” is herein understood a polyester (co)polymer which due to the low chain length cannot be effectively used in commercial applications. Typically, the number of repeating units in the polyester (co)polymer of insufficient chain length is below 50 units, suitably even below 30 units.

In the process of the invention, any relevant diol may be used. Particularly, at least a secondary diol is used. Such secondary diol may be selected from cyclic or non-cyclic, preferably aliphatic, diols. Preferred examples of non-cyclic aliphatic diols are vicinally substituted diols, such as 2,3-butanediol. Particularly, the invention relates to a process wherein the polyester (co)polymer of insufficient chain length having mainly hydroxy end groups comprises at least one diol derived monomer unit selected from (bi)cyclic secondary diols, in particular from 1,4:3,6-dianhydrohexitols, cis- and/or trans-2,2,4,4-tetramethyl-1,3-cyclobutanediol. The group of 1,4:3,6-dianhydrohexitols consists of isosorbide (1,4:3,6-dianhydro-D-sorbitol), isoidide (1,4:3,6-dianhydro-L-iditol) and isomannide (1,4:3,6-dianhydro-D-mannitol). In preferred embodiments, isosorbide is the only secondary diol used in the process.

In the stepwise process, as described above, in a first step a polyester (co)polymer of insufficient chain length having mainly hydroxy end groups is provided or produced. Producing said polymer is suitably done by (trans)esterification, optionally followed by polycondensation. Said polymer may also be provided as a result from other processes, which may be performed separately, even in a different reactor, and off-site. For example, suitable polyester (co)polymer of insufficient chain length may be terephthalate oligomers with mainly hydroxy end groups, e.g. produced by recycling processes, such as PET glycolysis products, e.g. PET oligomers (see e.g. T. Spychaj in “Handbook of thermoplastic polymers”, 2002 Wiley, Chapter 27, p 1259-61). Accordingly, in a preferred embodiment, the polyester (co)polymer of insufficient chain length having mainly hydroxy end groups is a recycled polyester material or derived from a recycled polyester material.

The currently claimed process, using the highly reactive diguaiacyl chain extender, has demonstrated to solve problems previously encountered with the low reactivity of isosorbide. The high reactivity of diguaiacyl chain extender allows to select polymerization conditions relatively mild and reaction times relatively short, even when no catalyst is added. The process of this invention is therefore preferable for the production of (co)polymers from isosorbide with high molecular weights, which is also applicable for larger scales.

Interesting polymer compounds can be prepared by using the chain extender according to the present invention, especially when at least one diol is isosorbide, thereby producing polyester (co)polymers comprising at least isosorbide units. Properties like biodegradability and lifetime of polyisosorbide (co)polymers can effectively be tuned by carefully selecting other monomer units to be built into the polymer structure.

Other, or additional (in addition to secondary diols), diols that may be used in the process of the invention are suitably selected from C2-C18 aliphatic diols. Preferably, the polyester (co)polymer of insufficient chain length having mainly hydroxy end groups comprises at least one diol derived monomer unit selected from C2-C18 aliphatic diols, in particular from linear, cyclic or branched, saturated C2-C12 aliphatic diols, especially selected from ethylene glycol, 1,3-propanediol, 1,4-butanediol, 1,5-pentanediol, 1,6-hexanediol, diethyleneglycol, neopentylglycol and 1,4-cyclohexanedimethanol. In particular, 1,4-cyclohexanedimethanol and 1,3-propanediol are preferred diols, especially for improving impact strength of the polyester (co)polymer.

In a preferred embodiment, the process of the invention comprises adding the diguaiacyl dicarboxylate ester chain extender before polycondensation. It was found that, in a process of producing isosorbide containing polyester (co)polymers, the chain extension effect (i.e. higher molecular weight) was most significant when the chain extender is added after (trans)esterification and before polycondensation.

Preferably, the process of the invention comprises adding an amount of the diguaiacyl dicarboxylate diester of 10 to 80 mol %, preferably 20 to 75 mol %, and especially 30 to 70 mol %, with regard to the total amount of hydroxy end groups present in the polyester (co)polymer of insufficient chain length. Suitably, the amount of chain linker is calculated based on the total amount of hydroxyl end-groups present in the ¹H-NMR spectrum.

Particularly preferred examples of the process of the invention are:
a process comprising providing or producing a polyethylene terephthalate polymer of insufficient chain length having mainly hydroxy end groups, subsequently adding diguaiacyl terephthalate or diguaiacyl furanoate in an amount of 10 to 80 mol % with regard to the total amount of hydroxy end groups, and performing a polycondensation reaction during a period of time of in the range from equal to or more than 0.5 hour to equal to or less than 8.0 hours at a temperature of in the range from equal to or higher than 220° C. to equal to or lower than 300° C. at a pressure lower than 20 mbar;
a process comprising providing or producing a polyethylene furanoate polymer of insufficient chain length having mainly hydroxy end groups, subsequently adding diguaiacyl furanoate in an amount of 10 to 80 mol % with regard to the total amount of hydroxy end groups, and performing a polycondensation reaction during a period of time of in the range from equal to or more than 0.5 hour to equal to or less than 8.0 hours at a temperature of in the range from equal to or higher than 220° C. to equal to or lower than 300° C. at a pressure lower than 20 mbar;
a process comprising producing a polyisosorbide co-cyclohexanedimethanol terephthalate polymer of insufficient chain length having mainly hydroxy end groups, subsequently adding diguaiacyl terephthalate in an amount of 10 to 80 mol % with regard to the total amount of hydroxy end groups, and performing a polycondensation reaction during a period of time of in the range from equal to or more than 0.5 hour to equal to or less than 5.0 hours at a temperature of in the range from equal to or higher than 250° C. to equal to or lower than 300° C. at a pressure lower than 20 mbar.
a process comprising providing or producing a poly(isosorbide-succinate) polymer of insufficient chain length having mainly hydroxy end groups, subsequently adding diguiacyl succinate in an amount of 10 to 80 mol % with regard to the total amount of hydroxy end groups, and performing a polycondensation reaction during a period of time of in the range from equal to or more than 0.5 hour to equal to or less than 8.0 hours at a temperature of in the range from equal to or higher than 220° C. to equal to or lower than 300° C. at a pressure lower than 20 mbar.

The process of the invention may be performed in the presence or absence of (trans)esterification/polycondensation catalysts. Therefore, another embodiment relates to the process according to this invention, comprising the use of a catalyst, preferably a metal-containing catalyst. The catalyst preferably is used in amounts from 0.01 mole % to 0.5 mole % with regard to the total amount of monomers (in moles). Such metal-containing catalyst may for example comprise derivatives of tin (Sn), titanium (Ti), zirconium (Zr), germanium (Ge), antimony (Sb), bismuth (Bi), hafnium (Hf), magnesium (Mg), cerium (Ce), zinc (Zn), cobalt (Co), iron (Fe), manganese (Mn), calcium (Ca), strontium (Sr), sodium (Na), lead (Pb), potassium (K), aluminium (Al), and/or lithium (Li). Examples of suitable metal-containing catalysts include salts of Li, Ca, Mg, Mn, Zn, Pb, Sb, Sn, Ge, and Ti, such as acetate salts and oxides, including glycol adducts, and Ti-alkoxides. Preferably the metal-containing catalyst is a tin-containing catalyst, for example a tin(IV)- or tin(II)-containing catalyst. More preferably the metal-containing catalyst is an alkyltin(IV) salt and/or alkyltin(II) salt. Examples include alkyltin(IV) salts, alkyltin(II) salts, dialkyltin(IV) salts, dialkyltin(II) salts, trialkyltin(IV) salts, trialkyltin(II) salts or a mixture of one or more of these. These tin(IV) and/or tin(II) catalysts may be used with alternative or additional metal-containing catalysts. A preferred metal-containing catalyst is n-butyltinhydroxide oxide.

Favorably, in another embodiment, the process according to the invention may be performed in the absence of a metal catalyst. Surprisingly, even when no metal catalyst is added in the process, high molecular weight polyester (co)polymers can be obtained.

The absence of a metal catalyst in the preparation of polyesters is most interesting from a sustainability and toxicity point of view. If such metal catalyst free polymers might find their fate in nature, or would be composted, no metal catalyst buildup or pollution of the metal salts in the environment would result. The absence of metal catalyst is also valuable for food and medical applications, where leaching of the catalyst could be a serious concern. In addition, also depletion of natural resources is getting problematic: since efficient removal of low amounts of metal catalyst (typically used in polyester synthesis) from waste plastics is almost impossible, depletion of rare metal reserves is a consequence of the use of such catalysts. This already is a big concern for antimony, which in fact is the preferred metal in PET catalysis.

The process according to the invention can be carried out in a batch-wise, semi-batchwise or continuous mode. The (trans)esterification stage and the polycondensation stage may conveniently be carried out in one and the same reactor, but may also be carried out in two separate reactors, for example where the (trans)esterification stage is carried out in a first (trans)esterification reactor and the polycondensation stage is carried out in a second polycondensation reactor.

In any introduction stage the monomers may be introduced into the reactor simultaneously, for example in the form of a feed mixture, or in separate parts. The monomers may be introduced into the reactor in a molten phase or they can be molten and mixed after introduction into the reactor.

The (trans)esterification stage is performed according to procedures known in the art, but is preferably carried out in a reaction time in the range from equal to or more than 0.5 hour, more preferably equal to or more than 1.0 hour, to equal to or less than 20.0 hour, preferably to equal to or less than 10 hours, more preferably equal to or less than 6.0 hour. During a (trans)esterification stage, the temperature may be stepwise or gradually increased. The esterification/transesterification stage is preferably carried out under an inert gas atmosphere, suitably at ambient pressure or slightly above that, e.g. up to 5 bar.

The polycondensation stage is performed according to procedures known in the art, but is preferably carried out in a reaction time in the range from equal to or more than 0.5 hour, more preferably equal to or more than 1.0 hour, to equal to or less than 8.0 hours, more preferably equal to or less than 6.0 hours. During a polycondensation stage, the temperature may be stepwise or gradually increased. The polycondensation may suitably be carried out at a temperature equal to or higher or a bit lower than the temperature at which the (trans)esterification stage is carried out depending on the type of polyester (co)polymers. The (trans)esterification stage may for example be carried out at a temperature in the range from equal to or higher than 170° C., and depending on the desired polyester (co)polymer (e.g. high Tg polymers) preferably equal to or higher than 210° C., and even more preferably equal to or higher than 230° C., to equal to or lower than 260° C.

The process according to the invention may optionally further comprise, in case the polymer is semi-crystalline, after a recovery stage (i.e. wherein the polyester (co)polymer is recovered from the reactor), a stage of polymerization in the solid state. That is, the polyester (co)polymer may be polymerized further in the solid state, thereby increasing chain length. Such polymerization in the solid state is also referred to as a solid state polymerization (SSP). Such a solid state polymerization may allow to further increase the number average molecular weight of the polyester (co)polymer. If applicable, SSP can further advantageously enhance the mechanical and rheological properties of polyester copolymers before injection blow molding or extruding. The solid state polymerization process preferably comprises heating the polyester (co)polymer in the essential or complete absence of oxygen and water, for example by means of a vacuum or purging with an inert gas. Generally, solid state polymerization may suitably be carried out at a temperature in the range from equal to or more than 150° C. to equal to or less than 220° C., at ambient pressure (i.e. 1.0 bar atmosphere corresponding to 0.1 MegaPascal) whilst purging with a flow of an inert gas (such as for example nitrogen or argon) or at reduced pressure, for example a pressure equal to or below 100 millibar (corresponding to 0.01 MegaPascal). The solid state polymerization may for example be carried out for a period in the range from equal to or more than 2 hours to equal to or less than 60 hours. The duration of the solid state polymerization may be tuned such that a desired final number average molecular weight for the polyester copolymer is reached.

Advantageously, this process does not alter the physical and chemical properties of the polymer produced at the end of the process. This is a significant advantage, especially when a polymer product is subjected to repeated recycling. Consequently, the polymer product properties are not changed by the current process, even after recycling. It is further advantageous for recycling processes to have no catalyst present in the polymer to avoid build-up of metals. Favorably, according to the process of the invention the use of a catalyst may be avoided.

In a further aspect, the invention relates to new (co)polyesters obtainable by, or obtained by, the currently claimed process. The process allows the preparation of a range of existing and novel polyester (co)polymers, often with high molecular weights that conventionally would not be obtainable. In another preferred embodiment no catalyst is used in the entire process, allowing the production of metal catalyst free polyester (co)polymers, that may be advantageous for certain uses requiring the absence of any catalyst, such as medical uses of polyesters. Thus, in an embodiment, preferably the (novel) polyester (co)polymer that is produced is a metal catalyst free (meaning: no metals present above ICP detection levels, i.e. less than 1 ppm metals present) polyester (co)polymer, i.e. which was produced without addition of a metal catalyst. Preferred polyester (co)polymers are metal catalyst free poly(isosorbide-co-1,4-cyclohexanedimethylene terephthalate), metal catalyst free poly(isosorbide succinate), metal catalyst free poly(ethylene terephthalate), and metal catalyst free poly(ethylene furanoate).

The amounts of each of the different monomeric units in the polyester (co)polymer often can be determined by proton nuclear magnetic resonance (¹H NMR). One skilled in the art would easily find the conditions of analysis to determine the amount of each of the different monomer units in the polyester (co)polymer. Other analysis methods can include depolymerization, followed by monomer quantification (versus standards). Polyesters can be depolymerized in water (hydrolysis), in alcohol, e.g. methanol (alcoholysis, e.g. methanolysis) or in glycol (glycolysis). An excess of depolymerization solvent ensures full depolymerization and a catalyst (e.g. a base) can accelerate the depolymerization.

The number average molecular weight (Mn) of the polyester (co)polymer(s) may vary and may depend for example on the added monomer type and amount, the presence or absence of a catalyst, the type and amount of catalyst, the reaction time and reaction temperature and pressure. Advantageously, the number average molecular weight of the polyester copolymer(s) according to the invention is at least equal to or more than 15000 grams/mole, particularly equal to or more than 18000 grams/mole, more preferably of equal to or more than 20000 grams/mole up to as high as 100000 grams/mole.

The weight average molecular weight (Mw) and the number average molecular weight (Mn) can be determined by means of gel permeation chromatography (GPC) at 35° C., using for the calculation poly(methyl methacrylate) (PMMA) or polystyrene (PS) standards as reference material, and using hexafluoro-2-propanol or dichloromethane, respectively, as eluent. All molecular weights herein are determined as described under the analytical methods section of the examples.

The glass transition temperature (Tg) of the polyester copolymer can be measured by conventional methods, in particular by using differential scanning calorimetry (DSC) with a heating rate of 10° C./minute in a nitrogen atmosphere. All glass transition temperatures herein are determined as described under the analytical methods section of the examples.

The process of the invention provides the person skilled in the art with tools and options to tune the desired properties of the polyester (co)polymers. For example, depending on the desired application, specific polyester (co)polymers may be made, e.g. by using isosorbide, which provide a desired biodegradability lifetime. This may be beneficial in the agriculture sector where coatings, bags, or packaging is temporary used for nutrition or protection of crops in the field. In addition, oxygen barrier properties of the polyester (co)polymers may be favorable, which is potentially interesting for coating and packaging with diminished environmental impact.

Any polyester (co)polymer obtainable by or obtained by the process of the invention can suitably be combined with additives and/or other (co)polymers in a composition. Such composition can for example comprise, as additive, nucleating agents. These nucleating agents can be organic or inorganic in nature. Examples of nucleating agents are talc, calcium silicate, sodium benzoate, calcium titanate, boron nitride, zinc salts, porphyrins, chlorin and phlorin.

The composition can also comprise, as additive, nanometric (i.e. having particles of a nanometric size) or non-nanometric and functionalized or non-functionalized fillers or fibres of organic or inorganic nature. They can be silicas, zeolites, glass fibres or beads, clays, mica, titanates, silicates, graphite, calcium carbonate, carbon nanotubes, wood fibres, carbon fibres, polymer fibres, proteins, cellulose fibres, lignocellulose fibres and nondestructured granular starch. These fillers or fibres can make it possible to improve the hardness, the stiffness or the permeability to water or to gases. The composition can comprise from 0.1% to 75% by weight, for example from 0.5% to 50% by weight, of fillers and/or fibres, with respect to the total weight of the composition. The composition can also be of composite type, that is to say can comprise large amounts of these fillers and/or fibres.

The composition can further comprise, as additive, opacifying agents, dyes and pigments. They can be chosen from cobalt acetate and the following compounds: HS-325 Sandoplast® Red BB, which is a compound carrying an azo functional group also known under the name Solvent Red 195, HS-510 Sandoplast® Blue 2B, which is an anthraquinone, Polysynthren® Blue R and Clariant® RSB Violet.

The composition can also comprise, as additive, a processing aid for reducing the pressure in the processing device. A mould-release agent, which makes it possible to reduce the adhesion to the equipment for shaping the polyester, such as the moulds or the rollers of calendering devices, can also be used. These agents can be selected from fatty acid esters and amides, metal salts, soaps, paraffins or hydrocarbon waxes. Specific examples of these agents are zinc stearate, calcium stearate, aluminium stearate, stearamide, erucamide, behenamide, beeswax or Candelilla wax.

The composition can also comprise other additives, such as stabilizers, etc. as mentioned herein above.

In addition, the composition can comprise one or more additional polymers other than the one or more polyester (co)polymers according to the invention. Such additional polymer(s) can suitably be chosen from the group consisting of polyamides, polystyrene, styrene copolymers, styrene/acrylonitrile copolymers, styrene/acrylonitrile/butadiene copolymers, polymethyl methacrylates, acrylic copolymers, poly(ether/imide)s, polyphenylene oxides, such as poly(2,6-dimethylphenylene oxide), polyphenylene sulfide, poly(ester/carbonate)s, polycarbonates, polysulphones, polysulphone ethers, polyetherketones and blends of these polymers.

The composition can also comprise, as additional polymer, a polymer which makes it possible to improve the impact properties of the polymer, in particular functional polyolefins, such as functionalized polymers and copolymers of ethylene or propylene, core/shell copolymers or block copolymers.

The composition can further comprise, as additional polymer(s), polymers of natural origin, such as starch, cellulose, chitosans, alginates, proteins, such as gluten, pea proteins, casein, collagen, gelatin or lignin, it being possible or not for these polymers of natural origin to be physically or chemically modified. The starch can be used in the destructured or plasticized form. In the latter case, the plasticizer can be water or a polyol, in particular glycerol, polyglycerol, isosorbide, sorbitans, sorbitol, mannitol or also urea. Use may in particular be made, in order to prepare the composition, of the process described in the document WO 2010/010282A1.

These compositions can suitably be manufactured by conventional methods for the conversion of thermoplastics. These conventional methods may comprise at least one stage of melt or softened blending of the polymers and one stage of recovery of the composition. Such blending can for example be carried out in internal blade or rotor mixers, an external mixer, or single-screw or co-rotating or counter-rotating twin-screw extruders. However, it is preferred to carry out this blending by extrusion, in particular by using a co-rotating extruder. The blending of the constituents of the composition can suitably be carried out at a temperature ranging from 220 to 300° C., preferably under an inert atmosphere. In the case of an extruder, the various constituents of the composition can suitably be introduced using introduction hoppers located along the extruder.

The compositions can be used to provide an article comprising a polyester (co)polymer prepared according to the process of the invention. The polyester (co)polymer may conveniently be used in the manufacturing of films, fibres, injection moulded parts and packaging materials, such as for example receptacles. The use of the polyester (co)polymer is especially advantageous where such films, fibres, injection moulded parts or packaging materials need to be heat-resistant or cold-resistant.

The article can also be a fibre for use in for example the textile industry. These fibres can be woven, in order to form fabrics, or also nonwoven.

The article can also be a film or a sheet. These films or sheets can be manufactured by calendering, cast film extrusion or film blowing extrusion techniques. These films can be used for the manufacture of labels or insulators.

This article can be a receptacle especially for use for hot filling and reuse applications. This article can be manufactured from the polyester (co)polymer or a composition comprising a polyester (co)polymer and one or more additives and/or additional polymers using conventional conversion techniques. The article can also be a receptacle for transporting gases, liquids and/or solids. The receptacles concerned may be baby's bottles, flasks, bottles, for example sparkling or still water bottles, juice bottles, soda bottles, carboys, alcoholic drink bottles, medicine bottles or bottles for cosmetic products, dishes, for example for ready-made meals or microwave dishes, or also lids. These receptacles can be of any size.

The article may for example be suitably manufactured by extrusion-blow moulding, thermoforming or injection-blow moulding.

The present invention therefore also conveniently provides a method for manufacturing an article, comprising the use of one or more polyester (co)polymers according to the invention and preferably comprising the following steps: 1) the provision of a polyester (co)polymer obtainable by or obtained by the process of this invention; 2) melting said polyester (co)polymer, and optionally one or more additives and/or one or more additional polymers, to thereby produce a polymer melt; and 3) extrusion-blow moulding, thermoforming and/or injection-blow moulding the polymer melt into the article.

The article can also be manufactured according to a process comprising a stage of application of a layer of polyester in the molten state to a layer based on organic polymer, on metal or on adhesive composition in the solid state. This stage can be carried out by pressing, overmoulding, lamination, extrusion-lamination, coating or extrusion-coating.

Advantageously, high molecular weight polyester (co)polymers produced according to the process of the invention can be used in 3D printing. In case very high molecular weights are desired, the use of alternative types of reactors could potentially be a solution, such as extruders and compounders that are known to be used with polymers produced with several types of chain extenders. For example, a spinning disk reactor is highly suitable for processing highly viscous polymers.

The invention is further illustrated by the following non-limiting examples.

### EXAMPLES

### List of Abbreviations

CHDM=1,4-cyclohexanedimethanol
DCM=dichloromethane
DiGu-TP=di-guaiacyl terephthalate
DiPh-TP=di-phenyl terephthalate
DiGu-S=di-guiacyl succinate
EG=end groups
GPC=Gel Permeation Chromatography
HFIP=hexafluoroisopropanol
IS=isosorbide
MEG=mono ethylene glycol
PDI=polydispersity index
PET=polyethylene terephthalate
PICT=poly(isosorbide-co-1,4-cyclohexanedimethylene terephthalate)
PIₓCT=PICT, wherein x indicates the isosorbide content (in mol %) relative to the repeating unit TPA
PISA=poly(isosorbide succinate)
PMMA=poly(methyl methacrylate)
RPM=rotations per minute
SSP=solid state polymerization
TCE=deuterated tetrachloroethane-d₂
TEA=triethylamine
THF=tetrahydrofuran
TMS=tetramethylsilane
TPA=terephthalic acid
TP-Cl=terephthaloyl chloride

### Materials and Reagents

Guaiacol from ACROS Organics (>99%) and terephthaloyl chloride from Sigma Aldrich (>99%) were used for the synthesis of the activated terephthalate compound using triethylamine as internal base. It was also used for the synthesis of di-guaiacyl-succinate. Purified terephthalic acid (TPA), commercially available isosorbide (IS), and 1,4-cyclohexanedimethanol (CHDM) were used for the polymerization reaction. The terephthalic acid (99%) was purchased from Acros Organics; isosorbide (≥99.9%) was acquired from Roquette Freres and 1,4-cyclohexanedimethanol (>99%) was purchased from TCl and is composed of approximately 70/30 mol % of trans/cis isomers. Commercially available succinic acid (≥99%) was purchased from Alfa Aesar and was used for the polymerization reaction and for the synthesis of di-guiacyl succinate. Butyltin hydroxide oxide hydrate (97%) from Sigma-Aldrich is used in small amounts (0.00138 molar equivalent) as the catalyst for the polymerization reaction.

### Characterization

### NMR

The chemical structure and composition of the PICT polymers were determined using ¹H-NMR spectroscopy. The analysis of PICT was performed using a 400 MHz liquid-state NMR spectrometer. Between 30 and 35 milligrams of each sample was dissolved in 0.7 ml deuterated tetrachloroethane-d₂ (TCE) or chloroform (CDCl₃). Chloroform was mostly used to measure samples after esterification, and TCE was mostly used for samples after polycondensation or polymers with higher molecular weight which were difficult to dissolve. Tetramethylsilane (TMS) was used as internal standard and the NMR measurements were recorded at 25° C. The polymer composition of the diols was determined by the relative integration area of the corresponding protons of isosorbide and CHDM in the NMR spectrum. The oxymethylene protons of isosorbide were combined to calculate the mol % of isosorbide inside the polymer relative to the repeating unit of TPA. Using the trans/cis ratio of the CHDM feed, the corresponding integrals were used to calculate the mol % of CHDM.

### DSC

The glass transition temperatures of the PICT polymers were measured with a Differential Scanning Calorimeter (DSC 3+ STARe from Mettler Toledo), under nitrogen gas flow (50 ml/min). The polymer samples were first heated from 10 to 300° C. at a rate of 10° C./min. Then the samples were cooled to 10° C. at a rate of 10° C./min. Finally, the samples were heated again to 300° C. at a rate of 10° C./min. The glass-transition temperature (T_{g}) of the polymer was taken at midpoint during the second heating scan.

### GPC

The number-average molecular weight (Mₙ) and weight-average molecular weight (M_{w}) were determined by Gel Permeation Chromatography with a LC column from Agilent (Agilent 1260 Infinity) using hexafluoroisopropanol (HFIP) as the solvent and poly(methyl methacrylate) (PMMA) as standard polymer for calibration. The molecular weights are estimated from data obtained by a VWR Hitachi 5450 RI detector. The corresponding polydispersity index (PDI) was calculated as well. Some samples that did not dissolve or could not be measured were dissolved in DCM and measured on a different GPC machine.

### Example 1

### Preparation of Diquaiacyl Terephthalate (Bis(2-Methoxyphenyl) Terephthalate)

Di-guaiacyl terephthalate (diGu-TP), is synthesized by reacting two equivalents of guaiacol with terephthaloyl chloride. THF is used as solvent and triethylamine (TEA) is used as internal base to neutralize the formed hydrochloric acid to form the corresponding triethylammonium chloride salt. Using an addition funnel the mixture of guaiacol (25.6 g; 0.21 mol) and TEA (21.4 g; 0.21 mol) in 240 ml THF was slowly added (˜10 ml/min) to a 3-neck flask containing 120 ml THF and TP-Cl (20.4 g; 0.10 mol). The reaction mixture was heated to 40-50° C. with a water bath while stirring with a top stirrer at 100 RPM. After complete addition of the guaiacol mixture, the reaction mixture was heated to 60° C. for 45-60 minutes. The color of the reaction mixture changed from yellow to white and all the TP-Cl was dissolved after about 45 minutes. After the reaction time the mixture was filtered over a glass filter while hot. The formed salt was washed twice with 100 ml warm THF (40-50° C.) and once with 100 ml cold THF. After washing the solvent THF was removed using a rotary vacuum evaporator. The product was redissolved in 300 ml DCM. Some white flakes remained undissolved. After washing with 200 ml NaHCO₃, 200 ml water and 200 ml brine in a separatory funnel, the organic layer was dried on magnesium sulfate. After removing the magnesium sulfate with a glass filter, the DCM was removed with the rotary evaporator. The product was dissolved in 300 ml THF at 70° C. to slowly recrystallize at room temperature. After recrystallizing overnight, the product was filtered with a glass filter and washed with 2×100 ml cold THF. After evaporation in the oven at 80° C. for 8 hours the final product was analyzed with ¹H-NMR, which confirmed that all THF was removed from the product. The yield was 15.8 g (41.9 mmol, 41.7% yield).

¹H-NMR Data of diGu-TP in CDCl₃

| Chemical | | | |
|---|---|---|---|
| shift (ppm) | Multiplicity | Integral | Structure |
| 3.75 | Singlet | 6.086 | O-methyl (a) |
| 6.94 | Multiplet | 4.074 | Aromatic Gu (b) |
| 7.11 | Doublet of | 2.017 | Aromatic Gu (c) |
| | doublets | | |
| 7.19 | Multiplet | 2.095 | Aromatic Gu (d) |
| 8.26 | Singlet | 4.000 | Aromatic TP (e) |

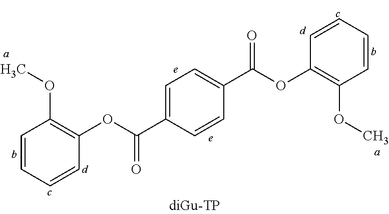 [SMILES: COc1ccccc1OC(=O)c1ccc(C(=O)Oc2ccccc2OC)cc1]

### Example 2

### Comparative Example—Preparation of PI₅₀CT Polyesters Using Conventional Procedure (No Chain Linker) See e.g. Legrand, S. Et al. European Polymer Journal 115 (2019) 22-29

PI₅₀CT polymers were synthesized in a 100 ml reactor via a two-step melt poly-condensation reaction: esterification followed by polycondensation. The reaction set-up was equipped with a mechanical stirrer with torque measurement, a collection flask to collect the distilled water or other volatiles (e.g., guaiacol), and a nitrogen-gas inlet. In the first step, around 10 grams of TPA was added, next CHDM and isosorbide were added with a 10% excess of isosorbide (1/1.1 acid/alcohol molar ratio). To achieve a 50/50 molar ratio of isosorbide and CHDM, a small excess of isosorbide was added to counter the lower reactivity of the isosorbide. For some reactions a lower excess of isosorbide was used, and the exact quantities of isosorbide were adjusted during the synthesis. Additionally, butyltin hydroxide oxide hydrate (˜17.3 mg) was added as catalyst.

First step. The reactor was heated to around 240° C. with an oil bath under nitrogen-flow (30 ml/min) to melt the monomer mixture. The esterification step was performed under nitrogen flow to prevent oxidation processes. When the mixture was molten the temperature was increased to 250° C. and constant stirring was applied at 100 RPM. After around 1 hour the temperature of the oil was increased to 260° C. During the esterification, PICT oligomers were formed (solids stuck on wall) and water was removed. The esterification time was approximately 10 hours. After the esterification, a homogeneous melt was reached indicating that all TPA solids were molten after heating. At the end of esterification, a sample was taken from the reaction mixture for ¹H-NMR analysis (15-40 mg in 0.7 ml CDCl₃).

In the second step, the temperature was increased to 285° C. and the pressure was reduced to 1 mbar to initiate the polycondensation. The pressure was slowly reduced in small steps starting from 400 mbar. Every 10 minutes the pressure was consecutively reduced to 300, 200, 100, 50, 20, 10, 5 and 0.1 mbar. The polycondensation conditions at 0.1 mbar were maintained for at least 1.5 to 2.5 hours. During the polycondensation the torque of the mechanical stirrer increased significantly over time at a certain stirring rate. The stirring speed was decreased slowly as the degree of polymerization increased. After around 1.5 hours of polycondensation time, the vacuum could often not be maintained while stirring due to the high torque. The mechanical stirrer was lowered to 50 and 30 RPM or stirred by hand when the vacuum could not be maintained. Finally, the pressure was returned to atmospheric pressure using nitrogen gas to prevent oxidative degradation and the resulting polyester was removed from the reactor. After 1.5 and 2.5 hours of full vacuum, polymer samples were taken and measured with ¹H-NMR (15-40 mg in 0.7 ml TCE) for composition analysis.

Results are shown in Table 1:

TABLE 1
Characteristics of PICT polymers with different feed
amounts of IS/CHDM. Esterification time of 10 hours.

| | | | | | Endgroups | | | | | |
|---|---|---|---|---|---|---|---|---|---|---|
| | Reaction | | Composition | | | CHDM | Properties | | | |
| | Feed | t_{pc} ^{b} | IS/CHDM ^{c} | IS loss | IS EG ^{c} | EG^{c} | Mₙ | M_{w} | | T_{g} |
| Sample | IS/CHDM ^{a} | [h] | [mol %] | [%] | [mol %] | [mol %] | [kDa] | [kDa] | PDI | [° C.] |
| PI₄₄CT: | 50.0/53.8 | 1.5 | 43.8/54.4 | 12.4 | 1.2 | 0.1 | 13.5 | 36.3 | 2.70 | 134 |
| 3% excess | | | | | | | | | | |
| CHDM | | | | | | | | | | |
| PI₄₆CT: 3% | 53.0/50.0 | 1.5 | 45.9/48.5 | 13.4 | 0.6 | 0.0 | 12.0 | 32.9 | 2.73 | 137 |
| excess IS | | | | | | | | | | |
| PI₄₉CT: 5% | 54.8/49.9 | 1.5 | 48.9/50.1 | 10.9 | 0.8 | 0.2 | — | — | — | 142 |
| excess IS | | 2.5 | 49.2/48.7 | 10.3 | 1.1 | 0.1 | 21.8 | 73.9 | 3.39 | 144 |
| PI₅₀CT: 10% | 59.5/50.1 | 1.5 | 49.6/48.4 | 16.6 | 1.9 | 0.2 | 16.7 | 41.3 | 2.47 | 141 |
| excess IS | | 2.5 | 49.8/47.7 | 16.2 | 1.7 | 0.1 | 21.2 | 50.9 | 2.40 | 143 |

^{a} Feed IS/CHDM relative to the feed amount of TPA.
^{b} t_{pc} indicates the total polycondensation time in hours.
^{c} Polymer composition IS/CHDM (mol %) or end-groups (EG) relative to the repeating unit TPA.

### Example 3

Preparation of PI₅₀CT Polyesters Using diGu-TP Chain Extender

For some experiments, the diGu-TP chain extender of Example 1 was added during a polymerization procedure as described in Example 2 to improve the properties of the polymer. Two different methods were applied: adding the chain linker after polycondensation and adding the chain linker before polycondensation (after esterification). The amount of chain extender was calculated based on the total amount of hydroxyl end-groups present in the ¹H-NMR spectrum after 10 hours of esterification or after 1.5 hours of polycondensation. Different amounts of the chain extender were tested corresponding to 33 mol % or 67 mol % of the amount of hydroxyl end-groups present before addition. (With each chain extender comprising two reactive ester groups, the amount of reactive ester groups that is added corresponds to respectively 66 mol % and 134 mol % of the amount of hydroxyl end-groups present before addition.)

After addition, the reaction mixture was stirred for 1 hour under nitrogen flow (30 ml/min) to mix the chain extender with the polymer mixture and to let it react. During some experiments the time under nitrogen flow was reduced to 15 minutes. Different samples were taken before and after addition to analyze for composition and end-groups with ¹H-NMR spectroscopy.

Results for reaction with diGu-TP added after polycondensation are shown in Tables 2 and 3.

TABLE 2
Characteristics PICT polymers: addition of 33 mol % diGu-TP of the hydroxyl
end-groups after polycondensation. Feed diols: 10% excess IS.

| | Reaction | | Composition | | Endgroups | | Properties | | | |
|---|---|---|---|---|---|---|---|---|---|---|
| Sample | t_{N2} | t_{pc} | IS/CHDM | IS loss | IS EG | CHDM EG | Mₙ | M_{w} | | T_{g} |
| taken | [h] | [h] | [mol %] | [%] | [mol %] | [mol %] | [kDa] | [kDa] | PDI | [° C.] |
| After est. ^{a} | 10 | 0.0 | 49.0/49.9 | 18.5 | 4.0 | 0.4 | — | — | — | — |
| After PC ^{a} | 10 | 1.5 | 50.0/50.4 | 16.8 | 1.2 | 0.1 | 23.8 | 63.1 | 2.65 | 145 |
| Add. 1 h-N₂ ^{b, c} | 11 | 1.5 | 49.6/48.4 | 17.5 | 1.5 | 0.1 | 17.1 | 40.6 | 2.38 | 142 |
| Add. 1 h- | 11 | 2.5 | 50.4/48.8 | 16.2 | 1.7 | 0.1 | 20.1 | 53.1 | 2.64 | 144 |
| vacuum ^{b, d} | | | | | | | | | | |

^{a} “est.” is abbreviation for esterification and “PC” for polycondensation.
^{b} “Add.” indicates a sample taken after adding the chain extender to the system. The chain extender is left to react, and a sample is taken after the indicated amount of hour(s).
^{c} “N₂” indicates the total time under nitrogen atmosphere after addition.
^{d} “vacuum” indicates the total time under vacuum after addition.

TABLE 3
Characteristics PICT polymers: addition of 67 mol % diGu-TP of the hydroxyl
end-groups after polycondensation. Feed diols: 10% excess IS.

| | | | | | Endgroups | | | | | |
|---|---|---|---|---|---|---|---|---|---|---|
| | Reaction | | Composition | | | CHDM | Properties | | | |
| Sample | | t_{pc} | IS/CHDM | IS loss | IS EG | EG | Mₙ | M_{w} | | T_{g} |
| taken | t_{N2} [h] | [h] | [mol %] | [%] | [mol %] | [mol %] | [kDa] | [kDa] | PDI | [° C.] |
| After est. | 10 | 0.0 | 49.3/48.2 | 17.1 | 4.2 | 0.3 | — | — | — | — |
| After PC | 10 | 1.5 | 50.1/49.2 | 15.6 | 2.5 | 0.1 | 18.5 | 40.1 | 2.17 | 141 |
| Add. 15 min- | 10.25 | 1.5 | 50.5/46.9 | 15.0 | 1.9 | 0.1 | 17.4 | 39.0 | 2.24 | 117 |
| N₂ | | | | | | | | | | |
| Add. 1 h- | 10.25 | 2.5 | 51.0/46.5 | 14.1 | 1.6 | 0.0 | 23.7 | 60.5 | 2.56 | 145 |
| vacuum | | | | | | | | | | |

Results for reaction with Di-GuTP added after esterification and before polycondensation are shown in Tables 4 and 5.

TABLE 4
Characteristics PICT polymers: addition of 33 mol % diGu-TP of the hydroxyl
end-groups before polycondensation. Feed diols: 10% excess IS.

| | | | Composition | | Endgroups | | | | | |
|---|---|---|---|---|---|---|---|---|---|---|
| | Reaction | | | IS | | CHDM | Properties | | | |
| Sample | t_{N2} | t_{pc} | IS/CHDM | loss | IS EG | EG | Mₙ | M_{w} | | T_{g} |
| taken | [h] | [h] | [mol %] | [%] | [mol %] | [mol %] | [kDa] | [kDa] | PDI | [° C.] |
| After est. | 10 | 0.0 | 49.4/49.0 | 18.0 | 4.9 | 0.4 | — | — | — | — |
| Add. 1 h-N₂ | 11 | 0.0 | 49.1/47.8 | 18.4 | 4.4 | 0.5 | — | — | — | — |
| Add. 1.5 h- | 11 | 1.5 | 50.8/46.6 | 15.6 | 1.6 | 0.1 | 25.5 | 66.8 | 2.62 | 143 |
| vacuum | | | | | | | | | | |
| Add. 2.5 h- | 11 | 2.5 | 50.6/47.4 | 15.9 | 0.7 | 0.1 | 29.3 | 97.5 | 3.33 | 147 |
| vacuum | | | | | | | | | | |

TABLE 5
Characteristics PICT polymers: addition of 67 mol % diGu-TP of the hydroxyl
end-groups before polycondensation. Feed diols: 10% excess IS.

| | | | Composition | | Endgroups | | | | | |
|---|---|---|---|---|---|---|---|---|---|---|
| | Reaction | | | IS | | CHDM | Properties | | | |
| | t_{N2} | t_{pc} | IS/CHDM | loss | IS EG | EG | Mₙ | M_{w} | | T_{g} |
| Sample taken | [h] | [h] | [mol %] | [%] | [mol %] | [mol %] | [kDa] | [kDa] | PDI | [° C.] |
| After est. | 10 | 0.0 | 49.4/49.8 | 17.7 | 5.6 | 0.5 | — | — | — | — |
| Add. 1 h-N₂ | 11 | 0.0 | 50.6/49.6 | 15.6 | 4.6 | 0.3 | — | — | — | — |
| Add. 1.5 h- | 11 | 1.5 | 51.6/47.7 | 14.0 | 2.0 | 0.2 | 20.9 | 40.1 | 1.91 | 146 |
| vacuum | | | | | | | | | | |
| Add. 2.5 h- | 11 | 2.5 | 51.6/47.7 | 14.1 | 2.1 | 0.1 | 24.9 | 56.9 | 2.28 | 147 |
| vacuum | | | | | | | | | | |
| Add. 3 h- | 11 | 3.0 | 51.0/47.4 | 14.9 | 1.2 | 0.1 | 22.7 | 66.1 | 2.92 | 147 |
| vacuum | | | | | | | | | | |

### Example 4

### Comparative Example—Preparation of PI₅₀CT Polyesters Using diPh-TP as Chain Linker

PICT synthesis with di-phenyl terephthalate as chain linker. In this experiment, 10% excess of isosorbide was used. The reaction was performed according to the procedure described in Examples 2 and 3.

In Table 6, the results are given for the PICT synthesis after adding diPh-TP before polycondensation. About 500 mg of diPh-TP was added (33 mol % diPh-TP of OH end-groups). Similar to previous examples, two different samples were measured at different polycondensation time. After 2.5 hours of polycondensation, the molecular weight is approximately 20 kg/mol with a T_{g} of 143° C. No improvement in molecular weight and T_{g} were obtained compared to the standard reaction with TPA and no chain linker (Example 2). These results were expected based on the reaction with diPh-TP as monomer, giving no significant improvement in characteristics as well.

TABLE 6
Characteristics PICT polymers: addition of 33 mol % diPh-TP of the hydroxyl
end-groups before polycondensation. Feed diols: 10% excess IS.

| | | | Composition | | Endgroups | | | | | |
|---|---|---|---|---|---|---|---|---|---|---|
| | Reaction | | | IS | | CHDM | Properties | | | |
| Sample | t_{N2} | t_{pc} | IS/CHDM | loss | IS EG | EG | Mₙ | M_{w} | | T_{g} |
| taken | [h] | [h] | [mol %] | [%] | [mol %] | [mol %] | [kDa] | [kDa] | PDI | [° C.] |
| After est. | 10 | 0.0 | 48.4/50.6 | 19.5 | 6.1% | 0.5% | — | — | — | — |
| Add. 1 h-N₂ | 11 | 0.0 | 50.1/49.0 | 16.6 | 5.9% | 0.5% | — | — | — | — |
| Add. 1.5 h- | 11 | 1.5 | 50.5/47.3 | 16.0 | 3.1% | 0.3% | 17.0 | 39.0 | 2.29 | 141 |
| vacuum | | | | | | | | | | |
| Add. 2.5 h- | 11 | 2.5 | 50.7/48.4 | 15.7 | 1.7% | 0.2% | 19.6 | 47.9 | 2.45 | 143 |
| vacuum | | | | | | | | | | |

### Example 5

### Preparation of Diguaiacyl Succinate (Bis(2-Methoxyphenyl) Succinate).

Di-guaiacyl succinate was synthesized by reacting one equivalent of succinic acid (81 mmol, 9.60 g) with 5 equivalents of guaiacol (i.e. o-methoxy phenol, 408 mmol, 50.7 g) with 0.14 mol % of catalyst butyltin hydroxide oxide hydrate (0.1 mmol, 0.02 g). The reaction was conducted under nitrogen flow (50 ml/min) in an oil bath, with oil temperature at 240° C. and reaction temperature at boiling point (202° C.), as evidenced by the reflux of guaiacol. Samples were taken for ¹H-NMR analysis, and the reaction was conducted for 45 hours. Later the excess of guaiacol was distilled off with vacuum at 240° C. (oil temperature). Confirmation of the structure and yield (˜98.6%) were made by NMR, using DMSO-d6 as solvent.

### Example 6

### Comparative Example—Preparation of PISA Polyesters Using Conventional Procedure (No Chain Linker)

The production of poly(isosorbide succinate), PISA, was conducted as a two-step melt polycondensation reaction. In a 3-neck round bottom flask of 250 ml, 70 g of succinic acid (59.3 mmol, 1 eq.) were added combined with 1.02 eq. of isosorbide and 0.14 mol % of butyltin hydroxide oxide hydrate. The reaction was conducted under nitrogen flow (50 ml/min) at 240° C. (oil bath temperature) for 20 hours at 100 rpm. Samples were taking to track its progress by ¹H-NMR using DMSO-d6 as solvent. After 20 hours, the reaction was deemed to reach an equilibrium state, therefore the product was distributed in storage flasks with ˜20 g of product each. These vials were then used as a starting point for the next step in the procedure, all being from the same initial batch (hereinafter referred to “batch 0”).

Then, ˜18 g of the batch 0 mixture was subject to vacuum, at 220° C., starting from 400 mbar and in 30 minutes reduced, gradually, to ˜0.5 mbar (full vacuum). The system was held under such conditions for 2 hours, with samples taken after 1 and 2 hours of full vacuum. These samples were analyzed by gel permeation chromatography (GPC) and differential scanning calorimetry (DSC).

For both examples 6 and 7, the DSC was run to 220° C., heating and cooling of 10° C./min. The T_{g} of each sample was obtained by analyzing the step in the second heating cycle. The GPC was run with dichloromethane as eluent, using polystyrene standards.

The results of Example 6 are shown in table 7.

TABLE 7
Characteristics PISA polymers: esterification time of 20 hours

| | Reaction | | Properties | | |
|---|---|---|---|---|---|
| Sample | t_{N2} | t_{pc}^{a} | Mₙ | | T_{g} |
| taken | [h] | [h] | [kDa] | PDI | [° C.] |
| After est. | 20 | 0.0 | 2.98 | 1.9 | 59.0 |
| After 1 h | 20 | 1.0 | 6.39 | 2.1 | 68.9 |
| vacuum | | | | | |
| After 2 h | 20 | 2.0 | 8.72 | 2.4 | 74.3 |
| vacuum | | | | | |

^{a}tpc indicates the total polycondensation time

### Example 7

The diGu-SA chain extender of Example 5 was added during a polymerization procedure as described in Example 6: 18.733 g of the batch 0 mixture was subjected to vacuum, at 220° C., starting from 400 mbar and in 30 minutes reduced, gradually, to ˜0.5 mbar (full vacuum). The system was held under such conditions for 1 hours, when a sample was taken and the system was allowed to cool down. The sample was analyzed by ¹H-NMR in order to check for composition, especially in terms of hydroxyl end groups. With these end groups quantified, the amount of chain extender was calculated. The amount of diGu-SA chain extender that was added to the system (1.0 g) corresponds to 24 mol % of the amount of hydroxyl end-groups present before addition. (With each chain extender comprising two reactive ester groups, the amount of reactive ester groups that is added corresponds to 48 mol % of the amount of hydroxyl end-groups present before addition.) The chain extender was added to the system under nitrogen flow, and heated to 220° C. The system was then stirred for 5 minutes and vacuum was again applied. Full vacuum was reached in 30 minutes, and then kept for 2 hours. Samples were taken after 1 hour of vacuum (so=1 h full vacuum after addition).

The results from Example 7 are shown in Table 8.

TABLE 8
Characteristics PISA polymers: addition of 24 mol % diGu-SA
of the hydroxyl end-groups after 1 h polycondensation.

| | Reaction | | Properties | | |
|---|---|---|---|---|---|
| Sample | t_{N2} | t_{pc}^{a} | Mₙ | | T_{g} |
| taken | [h] | [h] | [kDa] | PDI | [° C.] |
| After est. | 20 | 0.0 | 2.98 | 1.9 | 59.0 |
| After PC | 20 | 1.0 | 6.53 | 2.1 | 69.1 |
| Add. 1 h | 20 | 2.0 | 13.89 | 3.8 | 79.0 |
| vacuum | | | | | |

^{a}tpc indicates the total polycondensation time

1. A process for the production of a polyester (co)polymer, comprising the use of a diguaiacyl dicarboxylate ester as a chain extender, wherein the dicarboxylate is derived from a dicarboxylic acid selected from (hetero)aromatic dicarboxylic acids and from C3-C18 aliphatic dicarboxylic acids which are linear, cyclic or branched.

2. The process of claim 1, wherein the dicarboxylate is derived from a (hetero)aromatic dicarboxylic acid.

3. The process of claim 2, wherein the (hetero)aromatic dicarboxylic acid is selected from terephthalic acid, isophthalic acid or 2,5-furandicarboxylic acid.

4. The process of claim 1, wherein the dicarboxylate of the chain extender is derived from the same dicarboxylic acid that is used as monomers for the production of said polyester (co)polymer.

5. The process of claim 1, comprising a stepwise process, which comprises providing or producing a polyester (co)polymer of insufficient chain length having mainly hydroxy end groups, and subsequently adding the diguaiacyl dicarboxylate diester chain extender.

6. The process of claim 5, comprising adding the diguaiacyl dicarboxylate diester chain extender before polycondensation.

7. The process of claim 5, comprising adding an amount of the diguaiacyl dicarboxylate diester of 10 to 80 mol % with regard to the total amount of hydroxy end groups present in the polyester (co)polymer of insufficient chain length.

8. The process of claim 5, wherein the polyester (co)polymer of insufficient chain length having mainly hydroxy end groups comprises at least one diol derived monomer unit selected from C2-C18 aliphatic diols, from linear, cyclic or branched, saturated C2-C12 aliphatic diols.

9. The process of claim 5, wherein the polyester (co)polymer of insufficient chain length having mainly hydroxy end groups comprises at least one diol derived monomer unit selected from (bi)cyclic secondary diols from 1,4:3,6-dianhydrohexitols, cis- and/or trans-2,2,4,4-tetramethyl-1,3-cyclobutanediol.

10. The process of claim 1, comprising providing or producing a polyethylene terephthalate polymer of insufficient chain length having mainly hydroxy end groups, subsequently adding diguaiacyl terephthalate or diguaiacyl furanoate in an amount of 10 to 80 mol % with regard to the total amount of hydroxy end groups, and performing a polycondensation reaction during a period of time of in the range from equal to or more than 0.5 hour to equal to or less than 8.0 hours at a temperature of in the range from equal to or higher than 220° C. to equal to or lower than 300° C. at a pressure lower than 20 mbar.

11. The process of claim 1, comprising providing or producing a polyethylene furanoate polymer of insufficient chain length having mainly hydroxy end groups, subsequently adding diguaiacyl furanoate in an amount of 10 to 80 mol % with regard to the total amount of hydroxy end groups, and performing a polycondensation reaction during a period of time of in the range from equal to or more than 0.5 hour to equal to or less than 8.0 hours at a temperature of in the range from equal to or higher than 220° C. to equal to or lower than 300° C. at a pressure lower than 20 mbar.

12. The process of claim 4, wherein the polyester (co)polymer of insufficient chain length having mainly hydroxy end groups is a recycled polyester material or derived from a recycled polyester material.

13. The process of claim 1, comprising producing a polyisosorbide co-cyclohexanedimethanol terephthalate polymer of insufficient chain length having mainly hydroxy end groups, subsequently adding diguaiacyl terephthalate in an amount of 10 to 80 mol % with regard to the total amount of hydroxy end groups, and performing a polycondensation reaction during a period of time of in the range from equal to or more than 0.5 hour to equal to or less than 5.0 hours at a temperature of in the range from equal to or higher than 250° C. to equal to or lower than 300° C. at a pressure lower than 20 mbar.

14. The process of claim 1, performed in the absence of a metal catalyst.

15. A polyester (co)polymer obtainable by or obtained by a process according to claim 1.
